(19) United States
(12) Patent Application Publication
(10) Pub. No.: US 2013/0105603 A1
(43) Pub. Date: May 2, 2013

(54) Radiator Cleaning Air Wand

(71) Applicant: Darren S. Krankowsky, Opal (CA)

(72) Inventor: Darren S. Krankowsky, Opal (CA)

(21) Appl. No.: 13/281,737

(22) Filed: Oct. 26, 2011

(51) Int. Cl. B05B 15/06

(52) U.S. Cl. 239/532

(57) ABSTRACT

A cleaning air wand for the cleaning of radiators on automobiles or large tractor trailers includes a tube with a side-mounted discharge aperture which directs a high pressure stream of compressed air to clean surfaces and cooling elements of the radiator. An opposing end of the tube includes a ball valve which connects to a quick-connect compressed air fitting. In such a manner, a user can connect a flexible air hose to the ball valve and clean a motor vehicle radiator without the risk of further clogging as is the case when using a pressure washer.

### RELATED APPLICATIONS

Not Applicable

### FIELD OF THE INVENTION

The present invention relates generally to compressed air blow tools, and in particular, to a compressed air blow wand for cleaning debris from a vehicle radiator.

### BACKGROUND OF THE INVENTION

The proper operation of a cooling system is critical to any internal combustion engine. Those engines which use a coolant-based radiator rely on the fact that air can flow freely through, over, and past the radiator. Should this air flow become restricted, overheating, increased wear, and even complete engine failure can result. Mechanics and do-it-yourselfers often turn to the use of a water hose or pressure washer to help keep these radiators clean. However, in areas with fine dust, this practice is prone to turning the dust into a clogging paste and drive it into the radiator, which actually further restricts air flow instead of helping. This is especially a problem on large tractor trailer style trucks which can have multiple large radiators that frequently operate in extremely dusty environments. Additionally, traditional air guns do not provide proper direction of a compressed air flow to adequately remove the debris from a radiator.

### SUMMARY OF THE INVENTION

The inventor has therefore recognized the aforementioned inherent problems and lack in the art and observed that there is a need for an apparatus that provides air flow to the surface of radiators such that they are kept clean and operating at an optimum level. In accordance with the invention, it is an object of the present embodiments to solve at least one of these problems.

The inventor recognized these problems and has addressed this need by developing a radiator cleaning air wand for the cleaning of motor vehicle radiators in a manner which is quick, easy, and effective. The inventor has thus realized the advantages and benefits of providing an elongated rigid tube having an open inlet, a hollow interior for the passage of compressed air, and a closed end opposite said inlet. At least one (1) aperture is disposed through the tube perpendicular to a longitudinal axis of the tube and adjacent to the closed end for the dispersal of at least one (1) stream of compressed air from within the tube. A valve is connected to the tube inlet and in fluid communication with tube interior for selectively controlling a flow of the compressed air into the tube. An air hose fitting is connected to the valve and is in fluid communication with the valve. The air hose fitting is coupled to and is in fluid communication with a source of the compressed air.

In certain embodiments of the invention, the valve is a ball valve having a manually actuated lever for selectively opening and closing the valve. The valve includes a valve inlet threadingly coupled to the air hose fitting and a valve outlet affixed to the tube inlet. The valve lever is positioned at a fixed location relative to the aperture for providing a visual indication of a dispersal direction of the stream of compressed air.

In certain embodiments of the invention, a locating member is disposed on the tube adjacent to the tube inlet for providing a visual indication of a dispersal direction of the stream of compressed air.

Furthermore, the described features and advantages of the disclosure may be combined in various manners and embodiments as one skilled in the relevant art will recognize. The disclosure can be practiced without one (1) or more of the features and advantages described in a particular embodiment.

Further advantages of the present disclosure will become apparent from a consideration of the drawings and ensuing description.

### BRIEF DESCRIPTION OF THE DRAWINGS

The advantages and features of the present disclosure will become better understood with reference to the following more detailed description and claims taken in conjunction with the accompanying drawings, in which like elements are identified with like symbols, and in which:

FIG. 1 is an environmental view of a radiator cleaning air wand in accordance with the invention;

FIG. 2 is an exploded view of the radiator cleaning air wand;

FIG. 3 is a perspective view of the radiator cleaning air wand;

FIG. 4 is a perspective view of a first alternate tube of the radiator cleaning air wand in accordance with the invention; and,

FIG. 5 is a top view of a second alternate tube of the radiator cleaning air wand in accordance with the invention.

### DESCRIPTIVE KEY

10 radiator cleaning air wand

11 operator

12 vehicle

13 radiator

14 existing air hose

15 debris

16 air flow

20 ball valve

21 lever

22 valve inlet

23 valve outlet

24 air hose fitting

25 fitting inlet

26 fitting outlet

27 tube

28 tube inlet

29 closed end

30 aperture

31 welding technique

40 first alternate tube

41 alternate aperture

42 second alternate tube

43 locating member

### DETAILED DESCRIPTION OF THE PREFERRED EMBODIMENT

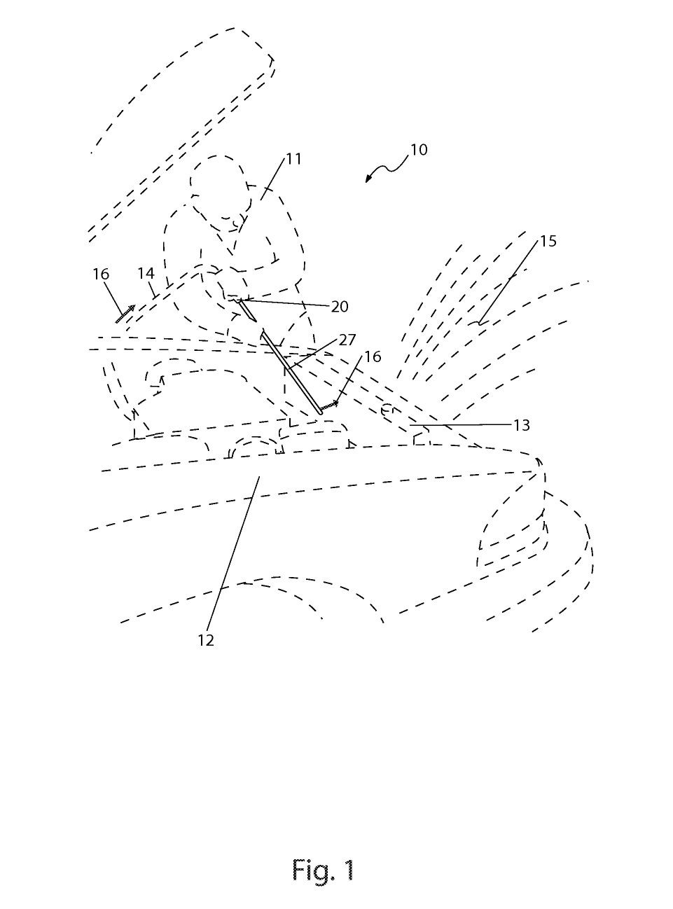

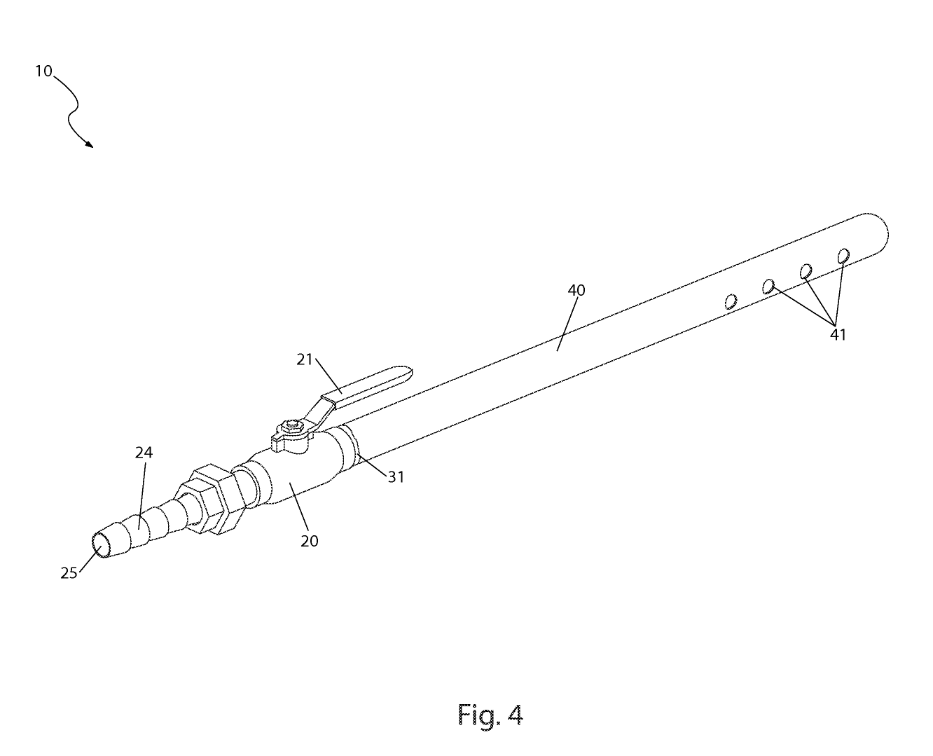

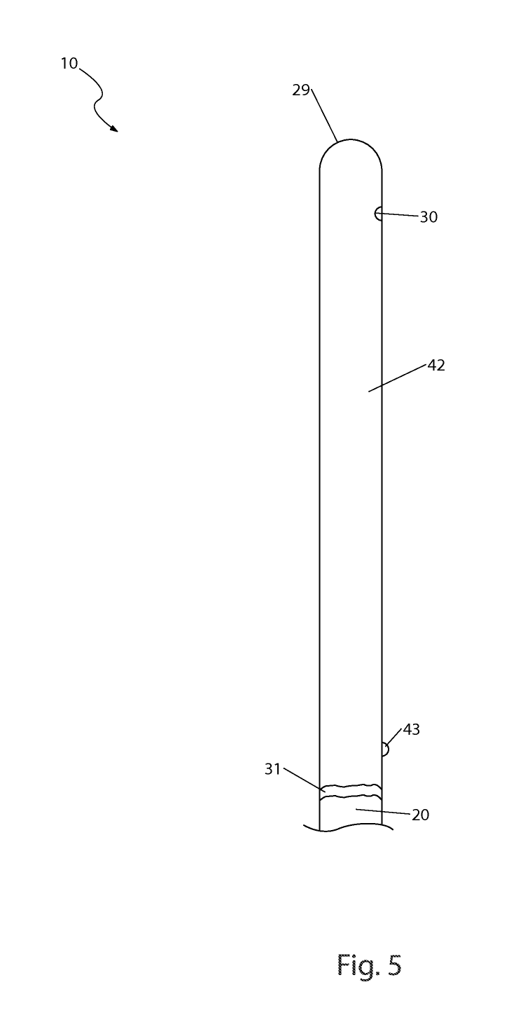

In accordance with the invention, the best mode is presented in terms of a preferred embodiment, herein depicted within FIGS. 1 through 3 and alternately within FIG. 4 and FIG. 5. However, the disclosure is not limited to a single described embodiment and a person skilled in the art will appreciate that many other embodiments are possible without deviating from the basic concept of the disclosure and that any such work around will also fall under its scope. It is envisioned that other styles and configurations can be easily incorporated into the teachings of the present disclosure, and only one particular configuration may be shown and described for purposes of clarity and disclosure and not by way of limitation of scope.

The terms “a” and “an” herein do not denote a limitation of quantity, but rather denote the presence of at least one of the referenced items.

Referring now to FIGS. 1 through 5, depicting a radiator cleaning air wand (herein described as an “apparatus”) 10, where like reference numerals represent similar or like parts. In accordance with the invention, the present disclosure describes the apparatus 10 for cleaning debris 15 from a radiator 13 utilizing compressed air 16. The apparatus 10 cleans the radiator 13 to enable the radiator 13 to function more efficiently in cooling an internal combustion engine in a vehicle 12.

FIG. 1 shows an environmental view of the apparatus 10. The apparatus 10 generally includes a ball valve 20, an air hose fitting 24, and a tube 27 which allows an operator 11 to insert and direct the apparatus 10 toward the radiator 13 of a vehicle, such as a car, tractor trailer, or the like to blow debris 15, such as, but not limited to: mud, insects, pebbles, or the like out of the radiator 13. The apparatus 10 interconnects to an air hose 14 which is also attached to and in fluid communication with an air compressor or pressurized air reservoir.

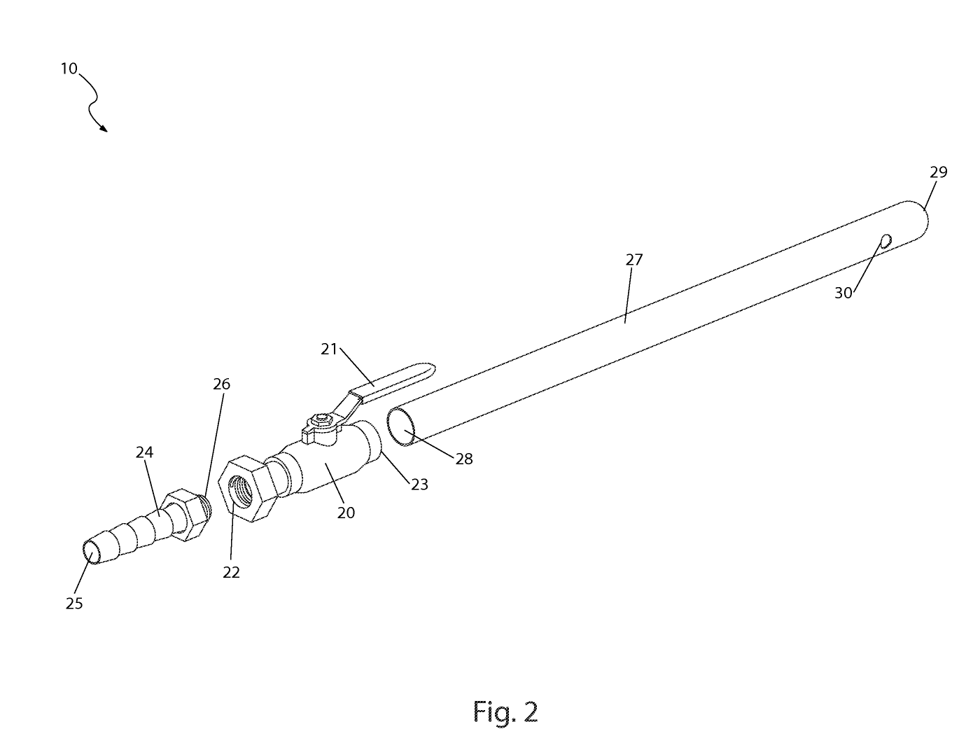

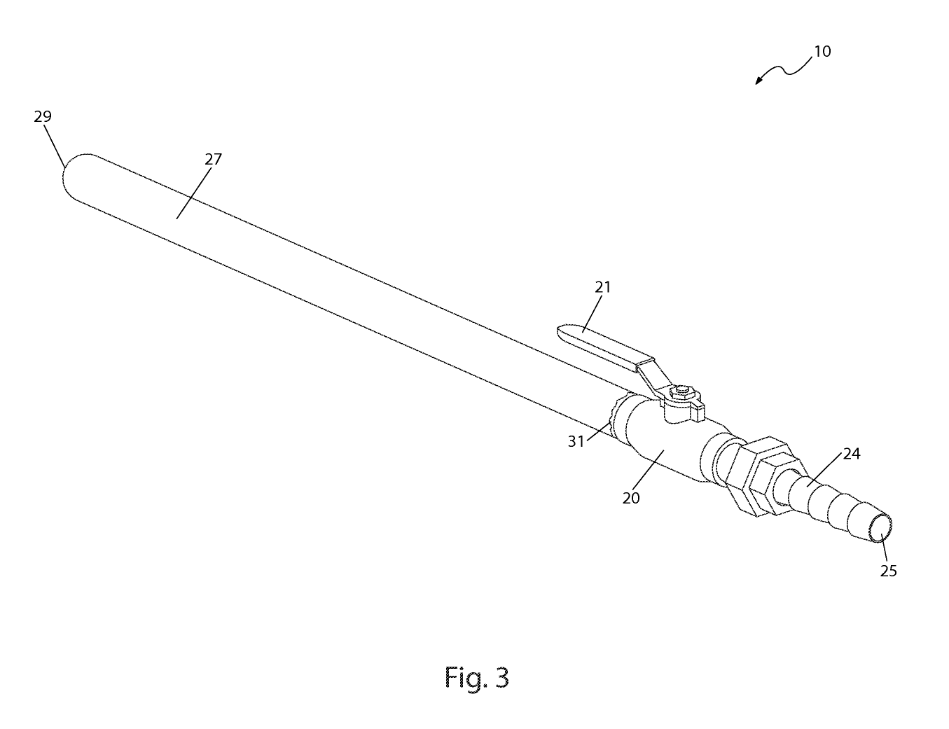

FIG. 2 shows an exploded perspective view of the apparatus 10 and FIG. 3 shows an unexploded opposing perspective view of the apparatus 10. The ball valve 20 is preferably a quarter (¼) inch dual position flow control device having a lever 21, a valve inlet 22, and a valve outlet 23. The lever 21 positions the ball valve 20 in an open or closed position to allow or restrict air flow 16, respectively. The valve inlet 22 has internal threads which interconnect to a fitting outlet 26 disposed on an end of the air hose fitting 24. The air hose fitting 24 is a coupler that interconnects the apparatus 10 to the supply compressed air. Opposing the fitting outlet 26 is a fitting inlet 25 that interconnects to the air hose 14 in an insertion slip-fit manner. The valve outlet 23 opposes the valve inlet 22 and is attached to the tube 27.

The tube 27 is an elongated hollow rod that provides a better reach for the operator 11 to direct and dispense the flow of air 16 into the radiator 13. The tube 27 can be attached to the valve outlet 23 by welding techniques, however; it can be appreciated that other material fastening techniques can be utilized without limiting the scope of the apparatus 10. The tube 72 includes an open end defining a tube inlet 28 that is coupled to the valve outlet 23. The tube 72 is in fluid communication with the ball valve 20 to provide air flow 16 through the tube 27 when the valve 20 is in the open position. The tube 27 also includes a closed end 29, opposite the tube inlet 28, that forces the air flow 16 to exit from and be dispersed through a single aperture 30 disposed adjacent to the closed end 29.

The tube 27 is preferably three-eighths (⅜) inch steel tubing measuring approximately between two (2) or six (6) feet in length to accommodate various styles and models of vehicle 12. The aperture 30 is offset approximately one-quarter (¼) inch from the closed end 29 and measures approximately seven-sixty-fourths ( 7/64) inch in diameter. The relatively small diameter of the aperture 30 provides a high pressure for the air flow 16 to contact the radiator 13. The ball valve 20 and the lever 21 are used to indicate the direction of the aperture 30 during use. The lever 21 can be directly opposite and aligned with the aperture 30, the aperture 30 can be positioned radially along the tube 27 ninety degrees (90°) from the lever 21, or the aperture 30 can be positioned one-hundred-eighty degrees (180°) opposite from the lever 21.

FIG. 4 shows a perspective view of a first alternate tube 40. The first alternate tube 40 includes a plurality of aligned, spaced apart alternate apertures 41. The alternate apertures 41 are spaced approximately a quarter (¼) inch to a half (½) inch apart and function in a similar manner as the aperture 30.

FIG. 5 shows a top view of a second alternate tube 42. The second alternate tube 42 is substantially similar to the tube 27 described herein and includes a locating member 43 to indicate to the operator 11 the position of the aperture 30 or alternate apertures 41 during use. During use, the working closed end 29 and the aperture 30, or apertures 41, may be hidden by vehicle components. The locating member 43 allows the user to quickly identify the location of the aperture(s) 30, 41 and thus the direction of the air flow 16. The locating member 43 is depicted as a protruding nub; however it can be appreciated that other external visual indicia can also be used with equal benefit. The locating member 43 can be directly opposite and aligned with the aperture 30, or apertures 41; the aperture 30, or apertures 41, can be positioned radially along the tube 27 ninety degrees (90°) from the locating member 43, or the aperture 30, or apertures 41, can be positioned one-hundred-eighty degrees (180°) opposite from the locating member 43.

It can be appreciated by one skilled in the art that other styles and configurations of the invention can be easily incorporated into the teachings of the present disclosure and only three particular configurations have be shown and described for purposes of clarity and disclosure and not by way of limitation of scope.

In accordance with the invention, the preferred embodiment can be utilized by the user in a simple and effortless manner with little or no training. After initial purchase or acquisition of the apparatus 10, it is installed and utilized as indicated in FIGS. 1 through 3.

The method of installing and utilizing the apparatus 10 can be achieved by performing a series of steps. It can be appreciated that the steps described can be performed in alternative order and as such should not be viewed as a limiting factor. Following acquisition of the apparatus 10, the fitting inlet 25 of the air hose fitting 24 is insertingly interconnected to the air hose 14. The air hose 14 is connected to a supply of compressed air if not already connected and the supply of compressed air is activated. The tube 27 is inserted into the engine compartment in close proximity to the radiator 13. Directing the aperture 30 toward the radiator 13 and actuating the lever 21 on the ball valve 20 to the open position to allow the compressed air flow 16 to exit. Utilizing the compressed air flow 16 to clean the radiator 13 by blowing away any residual dirt or debris. Actuating the lever 21 to close the ball valve 20 and prohibit the air flow 16.

An alternate embodiment of the apparatus 10 can further be utilized as indicated in FIG. 4. In addition to the steps described, in certain embodiments in accordance with the invention, when the first alternate tube 40 is used, the compressed air flow 16 is dispersed through the alternate apertures 41.

An alternate embodiment of the apparatus 10 can further be utilized as indicated in FIG. 5. In addition to the steps described, in certain embodiments in accordance with the invention, when the second alternate tube 42 is used the following steps are included. After acquiring the apparatus 10 and interconnecting the fitting inlet 25 to the air hose 14 and activating the air flow 16, the locating member 43 is utilized to determine the direction of the aperture 30, or apertures 41. The aperture 30, or apertures 41 are directed toward the radiator 13 and the lever 21 is actuated to the open position to provide the compressed air flow 16. The air flow 16 is routed through the second alternate tube 42 and is dispersed through the aperture 30, or apertures 41.

The foregoing descriptions of specific embodiments have been presented for purposes of illustration and description. They are not intended to be exhaustive or to limit the invention and method of use to the precise forms disclosed. Various modifications and variations can be appreciated by one skilled in the art in light of the above teachings. The embodiments have been chosen and described in order to best explain the principles and practical application in accordance with the invention to enable those skilled in the art to best utilize the various embodiments with expected modifications as are suited to the particular use contemplated. It is understood that various omissions or substitutions of equivalents are contemplated as circumstance may suggest or render expedient, but is intended to cover the application or implementation without departing from the spirit or scope of the claims of the invention.

What is claimed is:

1. A radiator cleaning air wand comprising:
an elongated rigid tube having an open inlet, a hollow interior for the passage of compressed air, and a closed end opposite said inlet;
at least one aperture disposed through said tube perpendicular to a longitudinal axis and adjacent to said closed end for the dispersal of said compressed air from within said tube;
a valve connected to and in fluid communication with said tube inlet for selectively controlling a flow of said compressed air into said tube; and,
an air hose fitting connected to and in fluid communication with said valve, said air hose fitting is coupled in fluid communication to a source of said compressed air.

2. The apparatus of claim 1, wherein said valve further comprises a manually actuated lever for selectively opening and closing said valve.

3. The apparatus of claim 2, wherein said valve further comprises a ball valve.

4. The apparatus of claim 3, wherein said valve further comprises a valve inlet threadingly coupled to said air hose fitting and a valve outlet affixed to said tube inlet.

5. The apparatus of claim 4, wherein said valve lever is disposed in alignment with said aperture for providing visual indication of a dispersal direction of said compressed air.

6. The apparatus of claim 4, wherein said valve lever is disposed ninety degrees from said at least one aperture for providing visual indication of a dispersal direction of said compressed air.

7. The apparatus of claim 4, wherein said valve lever is disposed one hundred eighty degrees from said at least one aperture for providing visual indication of a dispersal direction of said compressed air.

8. The apparatus of claim 2, further comprising a locating member disposed on said tube adjacent to said tube inlet for providing visual indication of a dispersal direction of said compressed air.

9. The apparatus of claim 8, wherein said locating member is disposed in alignment with said at least one aperture.

10. The apparatus of claim 8, wherein said locating member is disposed ninety degrees from said at least one aperture.

11. The apparatus of claim 8, wherein said locating member is disposed one hundred eighty degrees from said at least one aperture.

12. The apparatus of claim 12, wherein said locating member further comprises a nub protruding from an exterior of said tube.

13. A radiator cleaning air wand comprising:
an elongated rigid straight tube having an open inlet, a hollow interior for the passage of compressed air, and a closed end opposite said inlet;
an aperture disposed through said tube perpendicular to a longitudinal axis and adjacent to said closed end for the dispersal of said compressed air from within said tube;
a ball valve in fluid communication with said tube inlet for selectively controlling a flow of said compressed air into said tube, said valve further comprising a lever for selectively opening and closing said valve, a valve inlet, and a valve outlet affixed to said tube inlet; and,
an air hose fitting threadingly coupled to and in fluid communication with said valve;
wherein said air hose fitting is coupled in fluid communication to an air distribution hose of a source of said compressed air.

14. The apparatus of claim 13, wherein said valve lever is positioned at a fixed location relative to said aperture for providing a visual indication of a dispersal direction of said compressed air.

15. The apparatus of claim 13, further comprising a locating member disposed on said tube adjacent to said tube inlet for providing visual indication of a dispersal direction of said compressed air.

16. The apparatus of claim 15, wherein said locating member further comprises a nub protruding from an exterior of said tube.

17. A radiator cleaning air wand comprising:
an elongated rigid straight tube having an open inlet, a hollow interior for the passage of compressed air, and a closed end opposite said inlet;
a plurality of spaced apart aperture disposed through said tube perpendicular to a longitudinal axis and adjacent to said closed end for the dispersal of said compressed air from within said tube;
a ball valve in fluid communication with said tube inlet for selectively controlling a flow of said compressed air into said tube, said valve further comprising a lever for selectively opening and closing said valve, a valve inlet, and a valve outlet affixed to said tube inlet; and,
an air hose fitting threadingly coupled to and in fluid communication with said valve;
wherein said air hose fitting is coupled in fluid communication to an air distribution hose of a source of said compressed air.

18. The apparatus of claim 17, wherein said valve lever is positioned at a fixed location relative to said plurality of apertures for providing a visual indication of a dispersal direction of said compressed air.

19. The apparatus of claim 17, further comprising a locating member disposed on said tube adjacent to said tube inlet for providing visual indication of a dispersal direction of said compressed air.

20. The apparatus of claim 19, wherein said locating member further comprises a nub protruding from an exterior of said tube.
